(19) United States
(12) Patent Application Publication
(10) Pub. No.: US 2011/0040716 A1
(43) Pub. Date: Feb. 17, 2011

(54) INFORMATION TERMINAL DEVICE AND FUNCTION USE METHOD

(76) Inventor: Eriko Kato, Tokyo (JP)

Correspondence Address: Mr. Jackson Chen, 6535 N. STATE HWY 161, IRVING, TX, 75039, US

(21) Appl. No.: 12/681,406

(22) PCT Filed: Oct. 28, 2008
(86) PCT No.: PCT/JP2008/069532

§ 371 Date: Apr. 2, 2010

(30) Foreign Application Priority Data
Nov. 2, 2007 (JP) 2007-286797

(51) Int. Cl. G06N 5/02

(52) U.S. Cl. 706/50

(57) ABSTRACT

An information terminal apparatus generates and holds, for each operation of the user, operation record information which is representative of an association between information indicating operating states of the information terminal apparatus which correspond to operations of the user, information indicating functions of the information terminal apparatus which are to be shifted from the operating states by the user, and information indicating the number of times that the functions are executed. When the user carries out an operation, the information terminal apparatus extracts operation record information which matches the operating state of the information terminal apparatus corresponding to the operation, and displays operation candidate information that comprises the extracted operation record information. When either of the operation record information items is selected from the displayed operation candidate information, the information terminal apparatus executes a process based on the function corresponding to the selected operation record information.

### TECHNICAL FIELD

The present invention relates to an information terminal apparatus such as a mobile phone, a PDA (Personal Digital Assistant), etc., and a function using method for use in such an information terminal apparatus.

### BACKGROUND ART

Portable information terminal apparatuses such as mobile phones, PDAs (Personal Digital Assistants), etc. in recent years have been greatly advanced in terms of multifunctionality. Therefore, the user of such a portable information terminal apparatus needs to master various operating procedures for fully using all the functions thereof.

Generally, the functions that the user uses frequently are limited to some of the functions which the information terminal apparatus provides. However, the user is required to repeat the same operations even when the user uses those limited operations. Since the portable information terminal apparatus has a limited number of operation switches, the user needs to perform a tedious and time-consuming process of operating a plurality of switches and operating one switch a plurality of times in order to use a desired function. Various technologies have been proposed for the purpose of assisting the user in carrying out complex operations.

For example, Japanese Laid-Open Patent Application No. 2004-152276 (hereinafter referred to as Patent document 1) discloses an information terminal apparatus for saving a record of user operations as operation record information, predicting an operation to be carried out next by the user based on the operation record information, and assisting the user in inputting operations based on the prediction. Patent document 1 discloses that if the user carries out the predicted operation or if the operation carried out next by the user is not in agreement with the predicted operation, then the user is informed accordingly.

Japanese Laid-Open Patent Application No. 2005-004401 (hereinafter referred to as Patent document 2) discloses an automatic transaction apparatus which, when the user starts a transaction operation, displays a transaction operation guide based on the transaction operations carried out in the past by the user based on a record of operations, and, when the user carries out a transacting operation according to the transacting operation guide, updates the contents of the record of operations based on the transacting operation.

Japanese Laid-Open Patent Application No. 10-027089 (hereinafter referred to as Patent document 3) discloses a computer operation assisting apparatus for chronologically saving an operation carried out by the user and its type, and the type of an application activated by the operation, together with an operation command, as operation record information, extracting an operating procedure which agrees with the latest command sequence performed by the user from the operation record information, and predicting and presenting to the user a command to be performed next from the extracted operating procedure.

However, the information terminal apparatus disclosed in Patent document 1 only informs the user if the predicted operation is carried out or if the operation that is next carried out is not in agreement with the predicted operation. Each of the automatic transaction apparatus disclosed in Patent document 2 and the computer operation assisting apparatus disclosed in Patent document 3 serve to assist an input operation of the user. None of Patent documents 1 through 3 simplify operations themselves which the user carries out to use desired functions.

### SUMMARY

It is an object of the present invention to provide an information terminal apparatus which is capable of selecting and performing a function to be used by the user with simple operations, and a function using method for use in such an information terminal apparatus.

In an aspect of the present invention for achieving the above-described object, there is provided in accordance with the present invention an information terminal apparatus having a plurality of functions, comprising:

an information manager that generates, for each operation of the user, operation record information which is representative of an association between information indicating operating states of the information terminal apparatus which correspond to operations of the user, information indicating functions of the information terminal apparatus which are to be shifted from the operating states by the user, and information indicating the number of times that the functions are executed;

an operation record storage that stores said operation record information;

an operation predictor that extracts, from said operation record storage, operation record information which matches the operating state of said information terminal apparatus corresponding to an operation which is carried out by the user, and that generates operation candidate information that comprises the extracted operation record information;

a display that displays said operation candidate information; and

an executing section that, when the user selects either one of the operation record information from said operation candidate information displayed by said display, executes a process based on the function corresponding to the selected operation record information.

According to the present invention, there is also provided a function using method for the user to use one of a plurality of functions provided by an information terminal apparatus, said function using method enabling a computer to perform a sequence of:

storing, in a storage device, for each operation of the user, operation record information which is representative of an association between information indicating operating states of the information terminal apparatus, which correspond to operations of the user, information indicating functions of the information terminal apparatus, which are to be shifted from the operating states by the user, and information indicating the number of times that the functions are executed;

extracting, from said storage device, operation record information which matches the operating state of said information terminal apparatus corresponding to an operation which is carried out by the user, and generating and displaying, on a display, operation candidate information that comprises the extracted operation record information; and

when the user selects either of the operation record information items from said operation candidate information displayed by said display, executing a process based on the function corresponding to the selected operation record information.

### BRIEF DESCRIPTION OF THE DRAWINGS

FIG. 1 is a block diagram showing the configuration of an information terminal apparatus according to a first exemplary embodiment.

FIG. 2 is a table showing an example of operation record information held by the information terminal apparatus according to the first exemplary embodiment.

FIG. 3 is a diagram showing an example of operation candidate information displayed by the information terminal apparatus according to the first exemplary embodiment.

FIG. 4 is a flowchart of a processing sequence of a function using method according to the first exemplary embodiment.

FIG. 5 is a table showing an example of operation record information held by an information terminal apparatus according to a second exemplary embodiment.

FIG. 6 is a diagram showing an example of operation candidate information displayed by an information terminal apparatus according to a third exemplary embodiment.

FIG. 7 is a table showing an example of operation record information held by an information terminal apparatus according to a fourth exemplary embodiment.

### EXEMPLARY EMBODIMENT

The present invention will be described in detail below.

### First Exemplary Embodiment

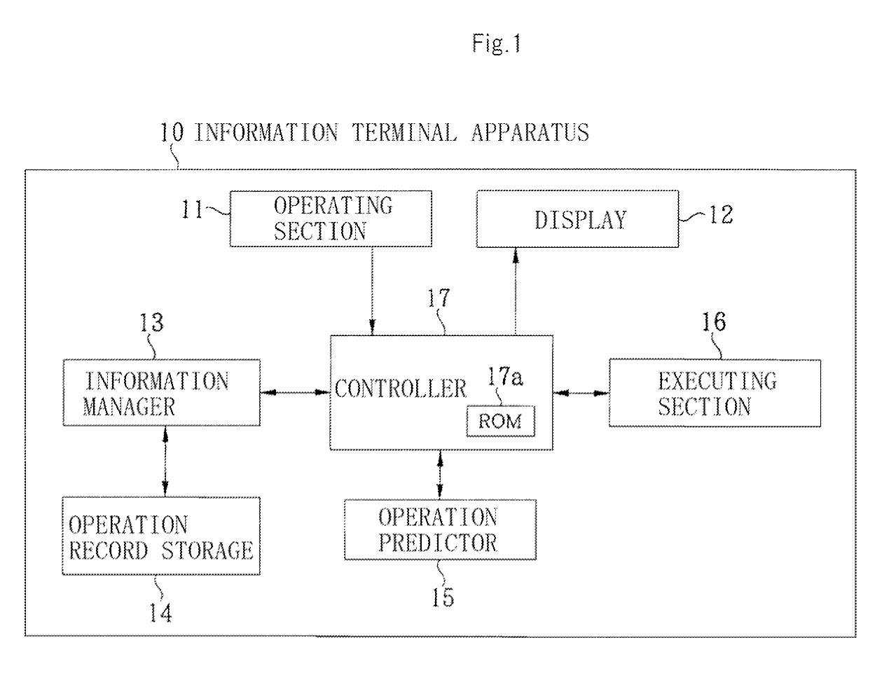

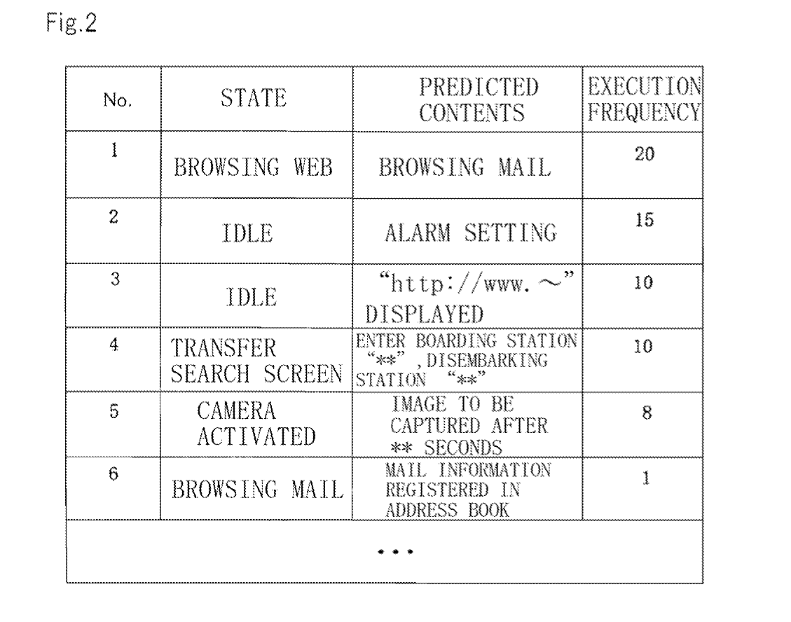

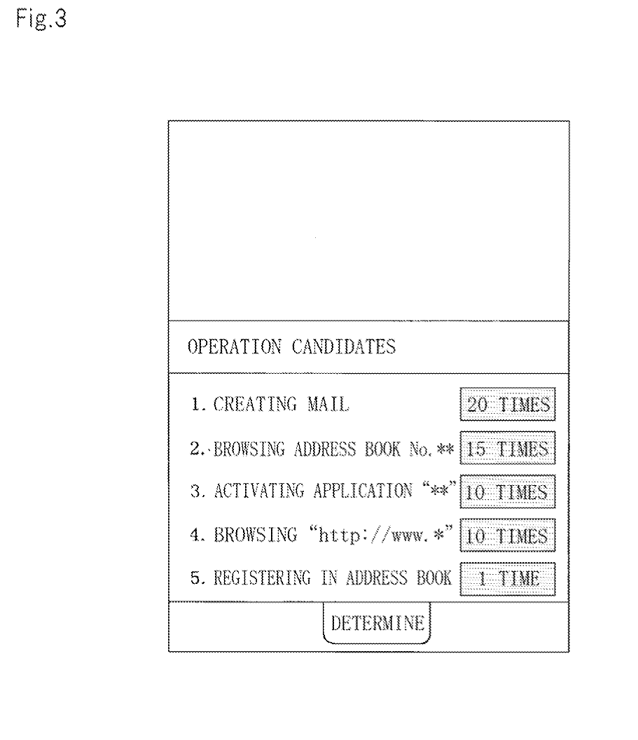

FIG. 1 is a block diagram showing the configuration of an information terminal apparatus according to a first exemplary embodiment. FIG. 2 is a table showing an example of operation record information held by the information terminal apparatus according to the first exemplary embodiment: FIG. 3 is a diagram showing an example of operation candidate information displayed by the information terminal apparatus according to the first exemplary embodiment.

As shown in FIG. 1, the information terminal apparatus according to the first exemplary embodiment comprises operating section 11, display 12, information manager 13, operation record storage 14, operation predictor 15, executing section 16, and controller 17. The information terminal apparatus shown in FIG. 1 is realized as an information terminal apparatus such as a mobile phone, a PDA, etc.

Operating section 11 has a plurality of button switches and is used by the user to select functions of information terminal apparatus 10 and to enter commands.

Information manager 13 generates operation record information based on the record of operations which the user has carried out using operating section, each time the user carries out an operation. As shown in FIG. 2, for example, the operation record information comprises information which is representative of an association between information (shown as “STATE” in FIG. 2) indicating operating states of information terminal apparatus 10 which correspond to operations of the user, information (shown as “PREDICTED CONTENTS” in FIG. 2) indicating functions of information terminal apparatus 10 which are to be shifted from the operating states by the user, and information (shown as “EXECUTION FREQUENCY” in FIG. 2) indicating the number of times that the functions are executed.

Operation record storage 14 comprises a storage device such as a RAM (Random Access Memory), a flash memory, or the like, and stores the operation record information generated by information manager 13. Operation record storage 14 has an upper limit on the number of operation record information items which it can hold depending on the memory capacity thereof. When information manager 13 stores new operation record information into operation record storage 14, if the number of operation record information items exceeds the upper limit, then information manager 13 deletes the operation record information which corresponds to the function that is executed least frequently by the user.

Operation predictor 15 checks the operating state of information terminal apparatus 10 which corresponds to the operation of the user against the operation record information stored in operation record storage 14, predicts the function of information terminal apparatus 10 which is to be shifted next from the operating state by the user, and extracts the operation record information which corresponds to the predicted function. Operation predictor 15 also generates operation candidate information made up of the extracted operation record information. If there are a plurality of operation record information items, then operation predictor 15 generates operation candidate information which is arranged successively from the operation record information which is executed most frequently by the user, for example.

Display 12 comprises a display device such as a liquid crystal display device, an organic EL (Electro-Luminescence) display, or the like, for example, and displays the operation candidate information generated by operation predictor 15, as shown in FIG. 3.

Executing section 16 executes a process depending on the function which corresponds to operation record information that is selected by the user from the operation candidate information displayed by display 12.

Controller 17 controls the overall operation of information terminal apparatus 10. Controller 17 is implemented by a computer which includes a CPU (Central Processing Unit) and ROM (Read Only Memory) 17a which stores a program for enabling the CPU to execute processes. As with controller 17, information manager 13, operation predictor 15, and executing section 16 can be implemented by a computer which includes a CPU and ROM which stores a program for enabling the CPU to execute processes. Information manager 13, operation predictor 15, executing section 16, and controller 17 may be implemented by a single computer or a plurality of computers.

A processing sequence of a function using method that is carried out by information terminal apparatus 10 according to the present exemplary embodiment will be described below with reference to the drawings.

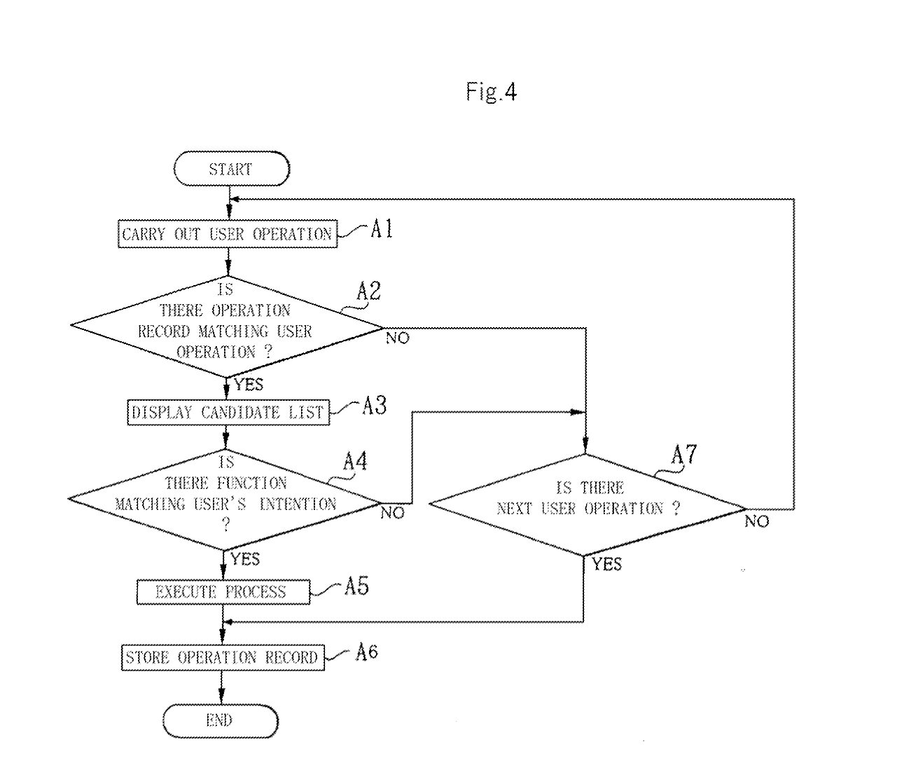

FIG. 4 is a flowchart of a processing sequence of a function using method according to the first exemplary embodiment.

As shown in FIG. 4, when the user carries out a desired operation using operating section 11 (step A1), controller 17 determines whether or not the operation record information which matches the present operating state corresponding to the operation is stored in operation record storage 14 (step A2).

If the operation record information which matches the present operating state is stored in operation record storage 14, then operation predictor 15 predicts a function of information terminal apparatus 10 which is to be shifted from the present state by the user based on the operation record information, and display 12 displays operation record information corresponding to the predicted function successively from the operation record information which is carried out frequently by the user, for example (step A3).

If the operation record information which matches the present operating state is not present, then controller 17 determines whether or not the user has carried out a next operation (step A7).

If the user has carried out a next operation in step A7, then information manager 13 generates new operation record information which is representative of an association between the previous operating state (“STATE” in FIG. 2) of information terminal apparatus 10, the function (“PREDICTED CONTENTS” in FIG. 2) of information terminal apparatus 10 which can be used by the next operation of the user, and the number of times (“EXECUTION FREQUENCY” in FIG. 2) that the function is executed, and stores the generated operation record information into operation record storage 14 (step S6). Thereafter, the processing sequence is ended. If the number of operation record information items exceeds the upper limit of operation record storage 14 by storing the new operation record information, then the operation record information which corresponds to the function that is executed least frequently by the user is deleted from operation record storage 14. If the user has not carried out a next operation in step A7, then information terminal apparatus 10 goes back to step A1, and waits for a next operation of the user.

Then, controller 17 monitors whether or not the user selects either one of the operation record information items which are displayed by display 12 in step A3, thereby determining whether or not the displayed operation record information includes a function that matches the intention of the user (step A4).

If the user selects either of the operation record information items which are displayed by display 12, then controller 17 judges that the operation record information includes a function that matches the intention of the user, and executing section 16 executes a process based on the function which corresponds to the operation record information selected by the user (step A5).

If the user does not select either of the operation record information items which are displayed by display 12 and continues the operation, then controller 17 judges that the operation record information does not include a function that matches the intention of the user. Control then goes to step A7 in which controller 17 determines whether or not the user has carried out a next operation.

After a process based on the function selected by the user is executed in step A5, information manager 13 updates a value representative of the number of times that the function executed in step A5 has been executed, and stores the updated operation record information into operation record storage 14 (step A6). Then, the processing sequence is ended.

The information terminal apparatus according to the first exemplary embodiment stores operation record information into operation record storage 14, predicts a function of information terminal apparatus 10 which is to be shifted from the present operating state by the user based on the operation record information, and displays operation candidate information representing the prediction on display 12. If the user selects either of the displayed operation candidate information items at this time, then information terminal apparatus 10 executes a process based on the function which corresponds to the selected operation candidate information. Therefore, the user can select and execute a function that is frequently used with a simple operation.

If the number of operation record information items stored in operation record storage 14 exceeds the upper limit determined by the memory capacity thereof, then information manager 13 deletes the operation record information which corresponds to the function that is executed least frequently by the user. Therefore, only the operation record information which corresponds to the functions that are executed relatively frequently by the user remains stored in operation record storage 14. As the period of time in which the information terminal apparatus is used becomes longer, the operation record information which corresponds to the functions that are executed frequently by the user is displayed, resulting in an increase in the predicting accuracy of operation predictor 15.

### Second Exemplary Embodiment

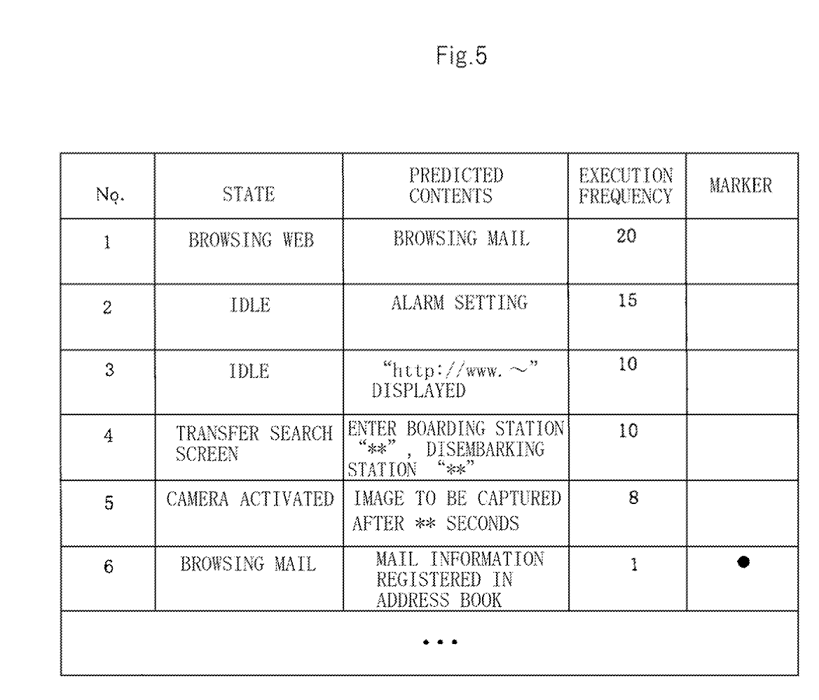

FIG. 5 is a table showing an example of operation record information held by an information terminal apparatus according to a second exemplary embodiment.

The information terminal apparatus according to the second exemplary embodiment is different from the information terminal apparatus according to the first exemplary embodiment as regards the process performed by information manager 13 shown in FIG. 1. Other configurational and processing details of the information terminal apparatus according to the second exemplary embodiment are the same as those of the information terminal apparatus according to the first exemplary embodiment and hence will not be described below.

Information manager 13 according to the second exemplary embodiment performs the same process as the process performed by information manager 13 shown in FIG. 1, and, in addition, excludes operation record information indicated by the user from the operation record information to be deleted from operation record storage 14.

Information manager 13 assigns a check mark () shown in FIG. 5, for example, to the operation record information that has been indicated by the user to be excluded from the operation record information to be deleted, from among the operation record information stored in operation record storage 14. If the number of operation record information items exceeds the upper limit of operation record storage 14 by storing new operation record information thereinto, then information manager 13 does not delete the operation record information having the check mark () assigned thereto from operation record storage 14 even if the number of operations carried out by the user is small.

Since the information terminal apparatus according to the second exemplary embodiment excludes the operation record information indicated by the user from the operation record information to be deleted, the user can use a function corresponding to the indicated operation record information with a minimum of operations. Therefore, any burden on the user who uses information terminal apparatus 10 for the first time or the user who is not accustomed to using information terminal apparatus 10 is reduced.

### Third Exemplary Embodiment

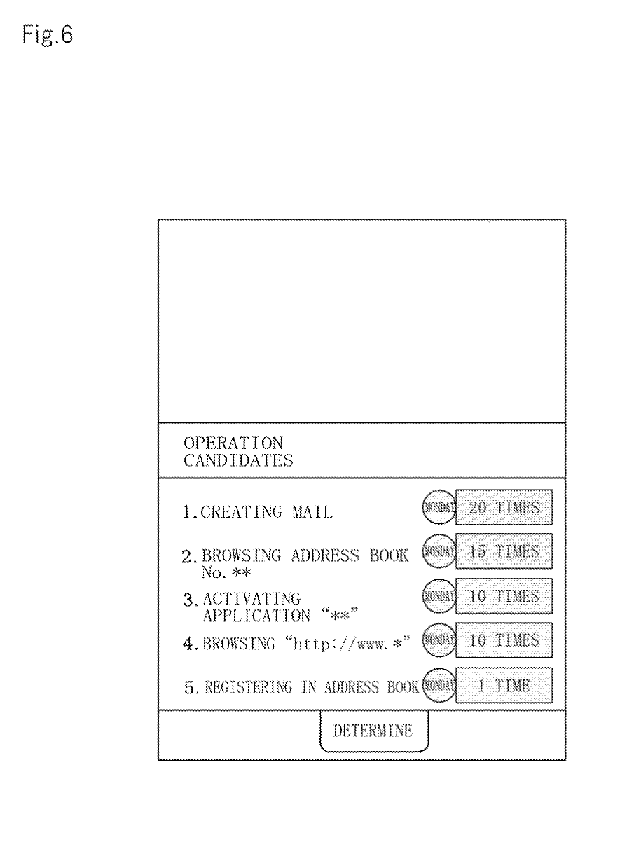

FIG. 6 is a diagram showing an example of operation candidate information displayed by an information terminal apparatus according to a third exemplary embodiment.

The information terminal apparatus according to the third exemplary embodiment is different from the information terminal apparatus according to the first exemplary embodiment and the information terminal apparatus according to the second exemplary embodiment as regards the process performed by information manager 13 and the process performed by operation predictor 15 shown in FIG. 1. Other configurational and processing details of the information terminal apparatus according to the third exemplary embodiment are the same as those of the information terminal apparatus according to the first exemplary embodiment and hence will not be described below.

Information manager 13 according to the third exemplary embodiment generates, in association with information indicating an operating state of information terminal apparatus 10 which corresponds to the operation of the user, operation record information including information which is representative of a function of information terminal apparatus 10 which is to be shifted from the operating state by the user, information indicating the number of times that the function has been executed, and time information (e.g., information indicating a day of the week) indicating times at which the function has been used, and stores the generated operation record information in operation record storage 14.

Operation predictor 15 according to the third exemplary embodiment extracts, from operation record storage 14, operation record information which matches the operating state of information terminal apparatus 10 corresponding to the present operation of the user and whose time information agrees with the time at which the operation is carried out, and successively generates operation candidate information that comprises the extracted operation record information from the operation record information which is carried out most frequently by the user, for example.

As shown in FIG. 6, display 16 successively displays operation record information including information (MONDAY) indicative of Mondays as time information, from the operation record information which is carried out most frequently by the user. The operation record information stored in operation record storage 14 can thus be classified according to a day of the week at which the operations are frequently carried out, making it possible to predict user operations according to the life style of the user.

The information indicative of a day of the week is used as the time information in the above example. However, the time information may comprise at least one the information items indicating a month, a date, a time zone, or a time at which functions have been used. According to such a modification, operation record information stored in operation record storage 14 can be classified according to a month, a date (the same date of each month), a time zone, a time, etc. at which the operations are carried out frequently, making it possible to predict user operations according to the life style of the user.

### Fourth Exemplary Embodiment

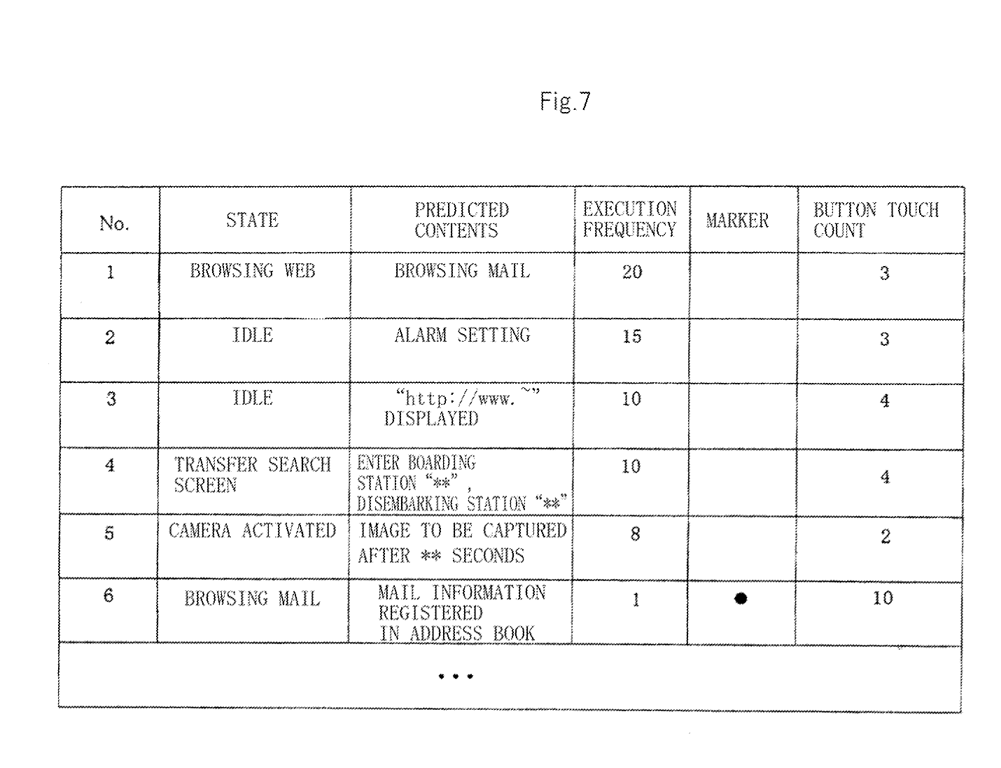

FIG. 7 is a table showing an example of operation record information held by an information terminal apparatus according to a fourth exemplary embodiment.

The information terminal apparatus according to the fourth exemplary embodiment is different from the information terminal apparatus according to the first through third exemplary embodiments as regards the process performed by information manager 13 shown in FIG. 1. Other configurational and processing details of the information terminal apparatus according to the second exemplary embodiment are the same as those of the information terminal apparatus according to the first exemplary embodiment and hence will not be described below.

Information manager 13 according to the fourth exemplary embodiment generates, in association with information (“STATE” in FIG. 7) indicating an operating state of information terminal apparatus 10 which corresponds to the operation of the user, operation record information including information (“PREDICTED CONTENTS” in FIG. 7) which is representative of a function of information terminal apparatus 10 which is to be shifted from the operating state by the user, information (“EXECUTION FREQUENCY” in FIG. 7) indicating the number of times that the function has been executed, and the number of times (“BUTTON TOUCH COUNT” in FIG. 7) that operating section 11 is operated until the function can be used, and stores the generated operation record information into operation record storage 14.

If the number of operation record information items exceeds the upper limit of operation record storage 14 by storing new operation record information, then information manager 13 according to the fourth exemplary embodiment deletes the operation record information indicative of a minimum number of operations (i.e., the function that can be used with the simplest operations).

If the number of operations is equal to or greater than a predetermined number, then information manager 13 according to the fourth exemplary embodiment excludes the operation record information corresponding to the function from the operation record information to be deleted from operation record storage 14.

Information manager 13 assigns a check mark () shown in FIG. 7, for example, to the operation record information whose number of operations is equal to or greater than a predetermined number, from among the operation record information stored in operation record storage 14. If the number of operation record information exceeds the upper limit of operation record storage 14 by storing new operation record information, then information manager 13 does not delete the operation record information having the check mark () assigned thereto from operation record storage 14 even if the number of operations carried out by the user is small. Operation record storage 14 thus stores operation record information indicative of operations with higher button touch counts (i.e., functions that require complex operations). Since information terminal apparatus 10 according to the fourth exemplary embodiment displays functions that require more complex operations as operation candidate information on display 12, the operability of information terminal apparatus 10 is increased.

The operation record information whose number of operations is equal to or greater than a predetermined number is excluded from the operation record information to be deleted in the above example. However, when the user carries out a given number of operations or more, controller 17 may display a pop-up screen or the like for assigning a check mark to a marker column on display 12 for the user to select whether or not a check mark is to be assigned to the operation record information of the function.

The present invention has been described above in reference to the exemplary embodiments. However, the present invention is not limited to the exemplary embodiments. Rather, changes that can be understood by those skilled in the art within the scope of the invention may be made to the arrangements and details of the present invention.

The present application claims priority based on Japanese patent application No. 2007-286797 filed on Nov. 2, 2007, and incorporates herein the entire disclosure thereof by reference.

1. An information terminal apparatus having a plurality of functions, comprising:
an information manager that generates, for each operation of the user, operation record information which is representative of an association between information indicating operating states of the information terminal apparatus which corresponds to operations of the user, information indicating functions of the information terminal apparatus which are to be shifted from the operating states by the user, and information indicating the number of times that the functions are executed;
an operation record storage that stores said operation record information;
an operation predictor that extracts, from said operation record storage, operation record information which matches the operating state of said information terminal apparatus corresponding to an operation which is carried out by the user, and generates operation candidate information that comprises the extracted operation record information;
a display that displays said operation candidate information; and
an executing section that, when the user selects either of the operation record information items from said operation candidate information displayed by said display, executes a process based on the function corresponding to the selected operation record information.

2. The information terminal apparatus according to claim 1, wherein the operation record information items extracted from said operation record storage comprises a plurality of operation record information, said operation predictor generates operation candidate information which is arranged successively from the operation record information which is executed most frequently by the user.

3. The information terminal apparatus according to claim 1, wherein said operation record storage has an upper limit for the number of operation candidate information items which can be stored thereby; and
said information manager deletes the operation record information corresponding to the function that is executed least frequently by the user from said operation record storage if the number of operation record information items exceeds said upper limit by storing new operation record information into said operation record storage.

4. The information terminal apparatus according to claim 3, wherein said information manager excludes operation record information indicated by the user from the operation record information to be deleted from said operation record storage, if the number of operation record information items exceeds said upper limit by storing new operation record information into said operation record storage.

5. The information terminal apparatus according to claim 1, wherein said information manager generates operation record information having time information which includes at least one information item indicating a month, a day, a day of the week, a time zone, or a time at which said functions are used, in association with the information indicating the operating states of the information terminal apparatus which correspond to the operations of the user; and
when the user carries out an operation, said operation predictor extracts, from said operation record storage, operation record information which matches the operating state of said information terminal apparatus corresponding to the operation and whose time information agrees with the time at which the operation is carried out, and generates operation candidate information that comprises the extracted operation record information successively from the operation record information which corresponds to the function that is performed most frequently by the user.

6. The information terminal apparatus according to claim 3, wherein said information manager generates said operation record information including information indicative of the number of operations carried out until the function can be used, in association with the information indicating the operating states of the information terminal apparatus which correspond to the operations of the user; and
said information manager deletes the operation record information corresponding to the function with respect to which said number of operations is minimum, from said operation record storage, if the number of operation record information items exceeds said upper limit by, storing new operation record information into said operation record storage.

7. The information terminal apparatus according to claim 6, wherein said information manager excludes operation record information corresponding to the function with respect to which the number of operations is equal to or greater than a predetermined number from the operation record information to be deleted from said operation record storage, if the number of operation record information items exceeds said upper limit by storing new operation record information in said operation record storage.

8. A function using method for the user to use one of a plurality of functions provided by an information terminal apparatus, said function using method enabling a computer to perform a sequence of:
storing, in a storage device, for each operation of the user, operation record information which is representative of an association between information indicating operating states of the information terminal apparatus, which correspond to operations of the user, information indicating functions of the information terminal apparatus, which are to be shifted from the operating states by the user, and information indicating the number of times that the functions are executed;
extracting, from said storage device, operation record information which matches the operating state of said information terminal apparatus corresponding to an operation which is carried out by the user, and generating and displaying, on a display, operation candidate information that comprises the extracted operation record information; and
when the user selects either of the operation record information items from said operation candidate information displayed by said display, executing a process based on the function corresponding to the selected operation record information.

9. The function using method according to claim 8, wherein the operation record information extracted from said operation record storage comprises a plurality of operation record information items, and said computer generates operation candidate information which is arranged successively from the operation record information which is executed most frequently by the user.

10. The function using method according to claim 8, wherein said storage device has an upper limit for the number of operation candidate information items which can be stored thereby; and
said computer deletes the operation record information corresponding to the function that is executed least frequently by the user from said storage device if the number of operation record information items exceeds said upper limit by storing new operation record information into said storage device.

11. The function using method according to claim 10, wherein said computer excludes operation record information indicated by the user from the operation record information to be deleted from said storage device, if the number of operation record information items exceeds said upper limit by storing new operation record information into said storage device.

12. The function using method according to claim 8, wherein said computer generates operation record information having time information which includes at least one information item indicating a month, a day, a day of the week, a time zone, or a time at which said functions are used, in association with the information indicating the operating states of the information terminal apparatus which correspond to the operations of the user; and
when the user carries out an operation, said computer extracts, from said storage device, operation record information which matches the operating state of said information terminal apparatus corresponding to the operation and whose time information agrees with the time at which the operation is carried out, and generates operation candidate information that comprises the extracted operation record information successively from the operation record information which corresponding to the function that is performed most frequently by the user.

13. The function using method according to claim 10, wherein said computer generates said operation record information including information indicative of the number of operations items carried out until the function can be used, in association with the information indicating the operating states of the information terminal apparatus which correspond to the operations of the user; and
said computer deletes the operation record information corresponding to the function with respect to which said number of operations is minimum, from said storage device, if the number of operation record information items exceeds said upper limit by storing new operation record information into said storage device.

14. The function using method according to claim 13, wherein said computer excludes operation record information corresponding to the function with respect to which the number of operations is equal to or greater than a predetermined number from the operation record information to be deleted from said storage device, if the number of operation record information items exceeds said upper limit by storing new operation record information into said storage device.
